(19) United States
(12) Patent Application Publication
(10) Pub. No.: US 2008/0309071 A1
(43) Pub. Date: Dec. 18, 2008

(54) SPLIT JOINT FOR VACUUM PUMPS AND METHOD FOR OBTAINING THEREOF

(75) Inventors: Roberto Carboneri, Settimo Torinese (TO) (IT); Jonatan Perrotta, Chivasso (TO) (IT); Sandro Vittozzi, Torino (IT)

Correspondence Address: Varian Inc.;Legal Department, 3120 Hansen Way D-102, Palo Alto, CA, 94304, US

(73) Assignee: Varian, Inc., Palo Alto, CA (US)

(21) Appl. No.: 12/139,252

(22) Filed: Jun. 13, 2008

(30) Foreign Application Priority Data
Jun. 15, 2007 (EP) 07425375.8

(51) Int. Cl. F16L 27/00

(52) U.S. Cl. 285/144.1

(57) ABSTRACT

A split joint (31) for vacuum pumps, suitable for establishing the mechanical connection and vacuum seal between the suction inlet (25) of a vacuum pump (35) and an evacuation outlet (65) of a structure (39) to which the pump is to be connected; said split joint comprising a male joint (33; 37) equipped with a plurality of male engagement elements (41; 43) connectable to the outer case of a vacuum pump or to the structure to which the pump is to be connected; said male engagement elements providing the mechanical connection with corresponding female engagement elements (41; 43) of the corresponding female joint; wherein the mechanical connection is achieved by a relative rotating movement between said male joint (33; 37) and said female joint (37; 33).

### CROSS-REFERENCE TO RELATED APPLICATIONS

The subject patent application is claiming priority of European Patent Application No. 07425375.8 filed in European Patent Office on Jun. 15, 2007.

### FIELD OF THE INVENTION

The present invention relates to a split joint for vacuum pumps.

More precisely, the invention relates to a split joint for vacuum pumps, for example pumps of the turbomolecular kind. The slit joint establishes a mechanical connection and vacuum seal between a vacuum pump suction inlet and an evacuation outlet of a device, for example a spectrographic device equipped with a vacuum chamber connected to the evacuation outlet.

### BACKGROUND OF THE INVENTION

Different types of vacuum pumps are used, depending on the desired degree of vacuum to achieve in the evacuated vessel. Turbomolecular pumps are typically utilized to obtain a high degree of vacuum, which is around 10⁻⁸ Pa. A pump of such kind is described for example in European publication EP 0,885,359.

FIG. 1 shows a longitudinal section of a conventional turbomolecular pump.

Usually, a turbomolecular pump comprises an outer case 11, generally cylindrical, inside which are mounted gas pumping stages 13, obtained by cooperation between stator rings 15, integral with the outer case 11 and rotor disks 17, integral with a rotating shaft 19, supported by ball bearings, respectively lower bearings 21a and upper bearings 21b, and driven by an electric motor 23 generally rotating at speed of at least 30,000 rpm, but in some pumps even reaching up to 100,000 rpm. The outer case 11 defines an axial inlet or suction port 25 for the intake of pumped gases, and is equipped with an outlet or evacuation port 27 for the evacuation of gases pumped through the pumping stages 13. The suction port 25 is generally bounded by a circumferential edge or flange 29 connecting the pump to an evacuation outlet of a device, which is generally equipped with a vacuum chamber, or of a conduit to which the pump is to be connected.

The connection between the vacuum pump and the outlet of the chamber which is to be evacuated, or of the conduit connected thereto, must ensure the correct mechanical positioning of the pump with respect to the outlet to guarantee a perfect vacuum seal even in the presence of vibrations caused by the operation of the pump or any other devices such as a pre-vacuum pump associated with the pumping system.

Conventional vacuum pumps, and particularly turbomolecular pumps, are connected to the vacuum chamber via a pair of flanges. A first flange is positioned on the pump and a second flange is secured by screws and/or by one or multiple clamps, a yoke or similar devices on the chamber. A mobile ring, generally metallic, also known as a centering ring, is placed between the flanges for providing the correct axial alignment of the flanges. An O-ring gasket, generally made of elastomer material, intends to guarantee the required vacuum seal.

The known connecting systems, however, have the disadvantages of being complex and cumbersome to use. Additionally, although the locking screws can be tightened with accuracy using for example a dynamometric key, this method can not ensure adequate compression of the O-ring sufficient enough to guarantee the appropriate seal between the pump and the chamber so as to avoid leaks in case of elevated degrees of pressure differential, such as the one created between the pumping channel inside the flanges and the outside environment. The operator may mount and start the pump without correct vacuum tight connection with the chamber to be evacuated. Moreover, the vibrations caused by the pump operation, due particularly to the high rotation speed of the rotor, can cause a loosening of the screws or bolts, and, as a result, a loss of the vacuum seal.

It is an object of the present invention to provide a connection joint for a vacuum pump, and particularly for a turbomolecular vacuum pump, that overcomes the drawbacks of the known art, by allowing a quick and reliable connection between the vacuum pump and the evacuated chamber.

It is another object of the invention is to provide a vacuum pump equipped with a connection joint which can be connected to any device, even by unskilled operators, using an easy and intuitive operation.

It is yet another object of the invention is to provide a method for obtaining a connection joint for vacuum pumps that is simple and economic, and that can be industrially applied with simple modifications.

### SUMMARY OF THE INVENTION

These and other objects are achieved by a split connection joint for a vacuum pump and by a method for obtaining said joint, as claimed in the attached claims.

Advantageously, the connecting joint according to the invention allows to connect a vacuum pump, particularly a turbomolecular vacuum pump, to an evacuation outlet, for example to the outlet of a device having a vacuum chamber by way of a simple and quick operation.

Advantageously, according to the invention, the securing of the joint is accomplished by the relative rotation between the male and the female elements of the joint along a short circumference arc, for example, less than 30°.

Furthermore, due to the joint according to the invention, it is possible to obtain an optimal mechanical connection and hydraulic seal between the pump and the evacuation outlet in a simple way readily available to any pump operators.

The connection joint is able to maintain both a mechanical connection and a hydraulic seal even during prolonged operation of the pump, which, as is known, is a source of vibrations that can cause the loosening of the traditional coupling systems, generally using screws or other securing devices.

The connection joint according to the invention has a simple structure to manufacture, which does not request substantial modifications to the pump or to the structure to which the pump is be connected.

According to a particular embodiment of the invention, it is possible to obtain a double connection joint that can be used to connect the pump, for example, to a supporting structure or to a carrying container.

Some preferred embodiments of the invention, given by way of non limiting example, will be described further below referring to the attached drawings, wherein

### BRIEF DESCRIPTION OF THE DRAWINGS

FIG. 1 shows a longitudinal section of a turbomolecular pump according to the known art;

FIGS. 2a and 2b show a prospective view of the joint according to a first embodiment of the invention, connected to a vacuum pump in open and secured positions, respectively;

FIG. 3a shows a side view of the flange of the joint of FIG. 2a;

FIG. 3b shows a diametrically opposed side view of the flange of FIG. 3a;

FIG. 3c shows a front view of the flange of FIG. 3a;

FIG. 4 shows a cross-section of the joint of FIG. 2a connected to a vacuum pump, in a secured position;

FIG. 5 shows a magnified view of a detail of the joint of FIG. 2a according to a variant of the embodiment;

FIG. 6a shows a perspective view of the joint in a second embodiment of the invention;

FIG. 6b is a magnified view of a detail of FIG. 6a when the joint is in an open position;

FIG. 6c shows a magnified view of a detail of FIG. 6a when the joint is in a secured position;

FIG. 7 shows a perspective view of a joint according to a third embodiment of the invention;

FIG. 8 shows a cross-section of a joint in a fourth embodiment of the invention;

FIG. 9a shows a side view of the flange of the joint of FIG. 8; FIG. 9b shows a diametrically opposed side view of the flange of FIG. 9a;

FIG. 10 shows a longitudinal section of a tool for assembling the joint;

FIG. 11 shows a schematic view of the method to use the tool of FIG. 10.

### DETAILED DESCRIPTION OF THE DRAWINGS

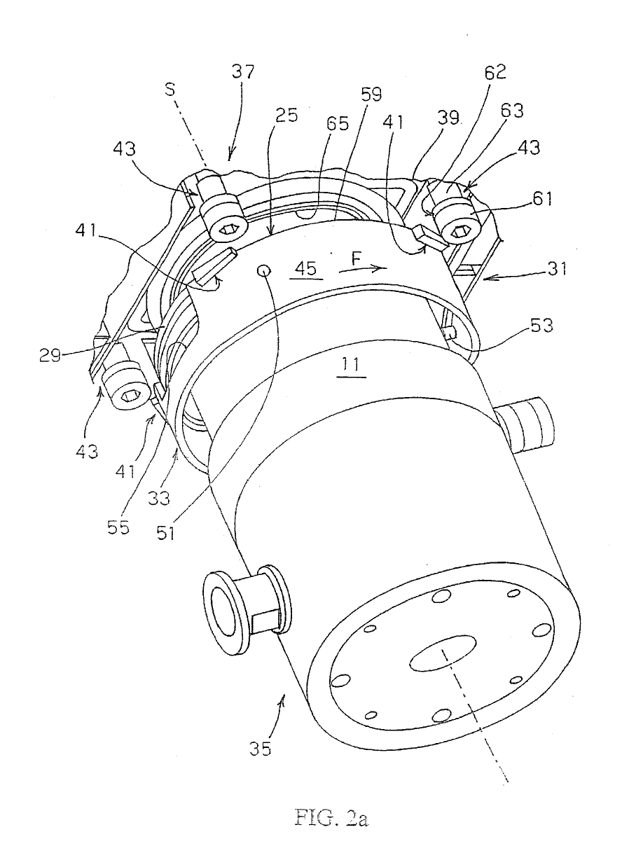

Referring to FIGS. 2a and 2b, a split joint for vacuum pumps is indicated as a whole by the reference 31. Split joint 31 is obtained by combining a male/female joint 33 with a female/male joint 37. Male/female joint 33 and female/male joint 37 are compatible with each other and designed to be connected in a way that guarantees a stable mechanical connection.

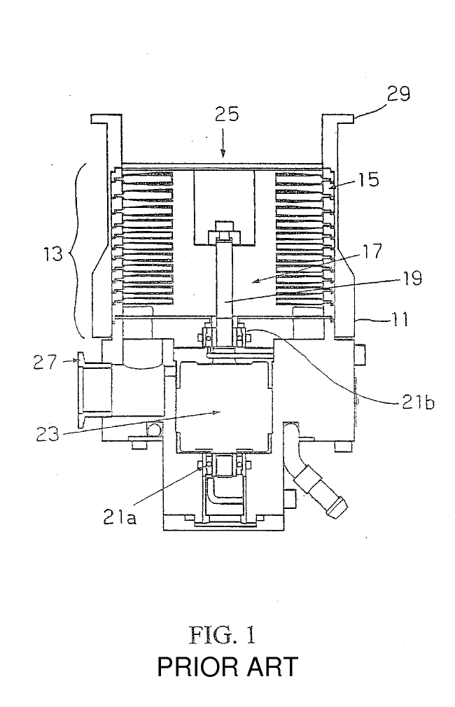

In the illustrated example, split joint 31 comprises a male joint 33, connected to a vacuum pump 35, which is a turbomolecular pump similar to the one shown in FIG. 1, and female joint 37 connected to a structure 39, corresponding, for example, with the structure or the outer case of a device having a vacuum chamber to be evacuated by the pump, to which structure the pump is to be connected using the split joint 31.

According to the invention, male joint 33 and female joint 37 are equipped with complementary male and female engagement elements 41 and 43, respectively, connectable to each other by relative rotating movement between male joint 33 and the female joint 37. The male joint 33 comprises a cylindrical flange 45 having a cross-section of a sufficient width to be mounted on the outer circumferential edge 29 of the suction port 25 of the pump 35 and radially protruding towards the outside of the outer case 11, defining a corresponding abutment surface used to secure the flange 45, as it will be clear from the following description.

The flange 45 has pass-through holes 51, preferably equidistant (at 120° in the illustrated example) to receive the corresponding securing elements 53, which consist, for example, of pins or screws arranged radially, which elements by interfering with the edge 29 of the pump prevent the flange 45 from being disengaged from the outer case 11 of the pump 35, after the pump has been connected to the flange 45 using a reciprocal approaching movement along the longitudinal axis S of the pump 35 and of the corresponding flange 45.

Preferably, according to the invention, the length of the pins or screws 53 and their arrangement on the flange 45 is chosen to allow the relative rotation of the flange 45 with respect to the pump 35 (preferably less than 30°, for example, 15°).

Alternatively, the flange 45 can also be made as a single body with the outer case 11 of the pump 35; however, in that case, it is evident that it would be necessary to rotate the pump 35 to obtain the rotation of the flange 45, and consequently, connecting the complementary male and female engagement elements 41 and 43. The flange 45 is preferably made of aluminum or other metallic material, but it could also be made of any suitable material, even non-metallic materials like, for instance, plastic or composite materials.

Advantageously, the flange 45 can further comprise one or more windows 55 to avoid an interference between the flange 45 and the components (not illustrated) possibly present in correspondence with the structure 39 to which the pump is to be connected using the split joint 31 and facilitate the manual rotation of the flange 45 required to engage and disengage the split joint 31, as will be evident in the following description.

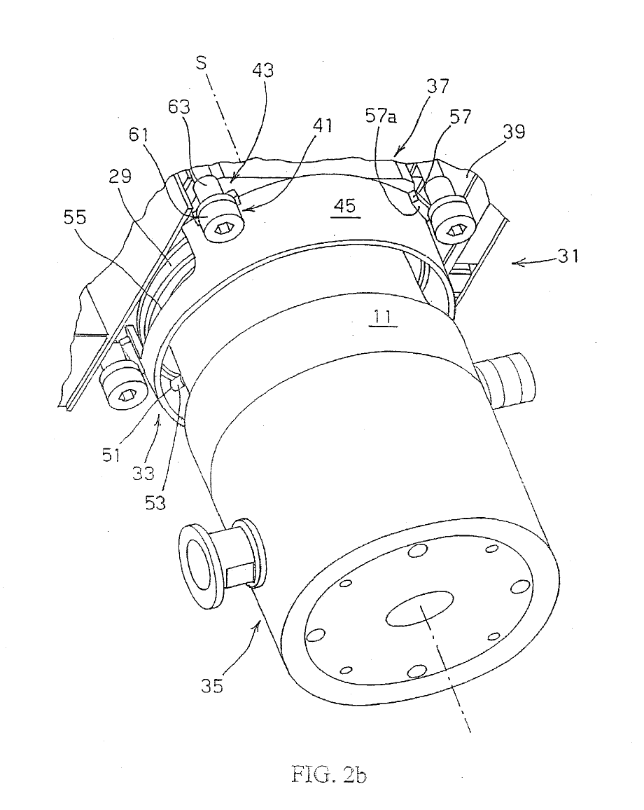

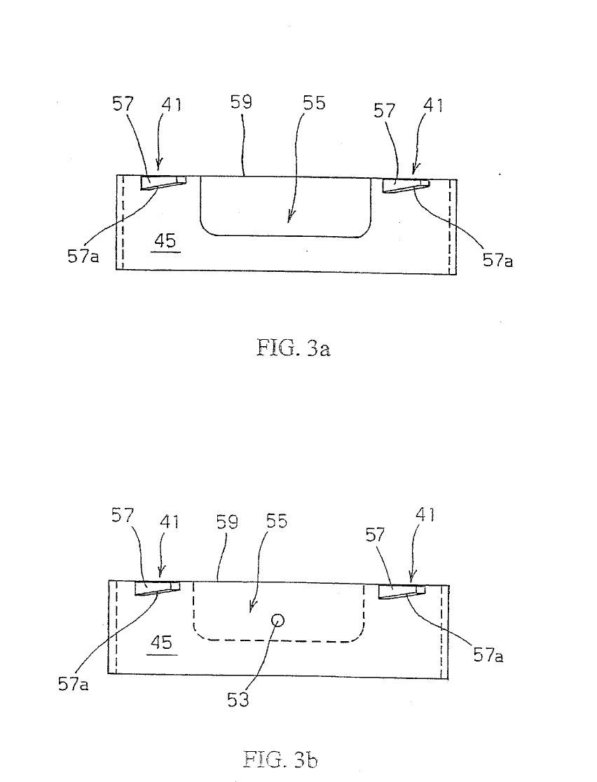

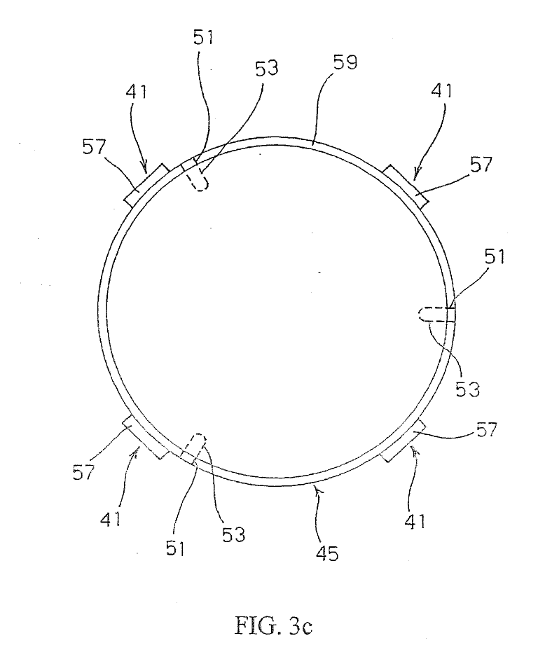

As better shown in FIG. 3a-3c, the engagement elements 41, provided in correspondence with the flange 45, comprise four wedge-shaped prongs 57 positioned on the lateral surface of the flange 45, and spaced out 90° from one another, in a circumferential pattern in proximity or along the front edge 59, which is intended to be positioned toward the structure 39. Preferably, the wedge-shaped prongs is positioned in a radial pattern, however, it is possible to have configurations in which said wedge-shaped prongs are extended axially from the edge 59.

In the example showing a turbomolecular pump of a medium size, in which the flange 45 has a diameter generally comprised between 100 and 200 mm, the wedge-shaped prongs 57 have a length of about 10-25 mm, preferably 15 mm, and the oblique surface 57a on the back surface of said wedge-shaped prongs 57 has an inclination comprised between 5° and 15°, preferably between about 8° and 9° with respect to the transversal plane of the flange 45.

Evidently, the dimensions of the prongs 57 and the inclination of the surface 57a will be chosen such as to guarantee a correct connection and a correct seal between the vacuum pump 35 on which the flange 45 is mounted and the evacuation outlet of the structure 39 to which the pump is connected.

Referring again to FIGS. 2a and 2b, the engagement elements 43, provided to be connected in correspondence with the structure 39, are obtained with corresponding bushings or washers or heads 61 defining female slots 62 connected to respective supports or columns or studs 63, which are, in turn, connected, for example by screwing in the corresponding threaded holes of the structure or frame 39, which surrounds the evacuation outlet 65 to which the suction inlet 25 of the vacuum pump is to be connected.

Advantageously, the columns 63 or the like is preferably positioned in correspondence with the vertices of a square centered on the opening 65, for a total of four engagement elements 43. The engagement elements 43 can be integrated into a unique ring nut, for example a circular ring nut surrounding the outlet 65, connected to the structure 39 using any kind of appropriate means, for example by welding or connected using screws and/or supporting brackets, or made as a single body with the structure 39.

Still referring to FIGS. 2a and 2b, the assembly of the split joint 31, according to this first embodiment the flange 45, without the securing elements 53 or with loosened securing elements 53, is mounted using an approaching movement along the longitudinal axis S on the vacuum pump 35 in correspondence with its suction inlet 25, and more precisely in correspondence with the edge 29 surrounding suction inlet 25. The securing elements 53 are then inserted or secured to prevent the flange 45 from being removed from the pump 35 due to a movement of the flange 45 in the opposite direction with respect to the previously used to mount the flange 45 on the pump 35. Correspondingly, when the engagement elements 43 are designed to be separable from the structure 39, they are connected, for example by screwing, to said structure 39 to which the pump 35 is to be connected. The joint 31 is then ready to be used to connect the pump 35 to the structure 39, and, correspondingly, to connect the suction inlet 25 to the evacuation outlet 65, while obtaining the required vacuum seal.

The pump 35 is then moved closer to the structure 39 in correspondence with the evacuation outlet 65 by using a reciprocal movement along the longitudinal axis S of the pump, which is then brought to substantially coincide with the evacuation outlet 65, to which the suction inlet 25 is to be connected (FIG. 2a); next, the flange 45 is slid axially forward to bring the securing elements 53 to interfere with the edge 29 of the pump, while eliminating any possible clearance; then the flange 45 is rotated clock-wise, right-handedly, in the direction of the arrow F in the illustrated example, to engage the wedge-shaped prongs 57 on the corresponding bushings 61 (FIG. 2b) obtaining the securing of the split joint 31.

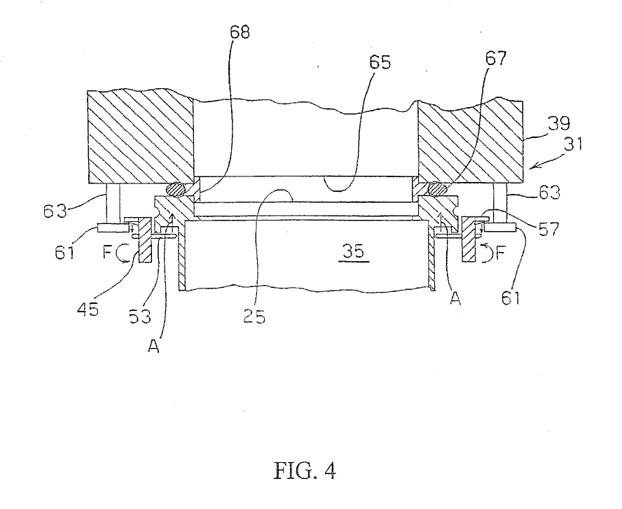

As better shown in FIG. 4, the rotation of the flange 45, once the wedge-shaped prongs 57 are engaged in the corresponding bushings 61, due to the wedge-shaped design of the prongs, generates an axial reaction force in the direction indicated by the arrows A that brings the suction inlet 25 of the pump closer to the evacuation outlet 65, while compressing the O-ring 67 interposed between suction inlet 25 and evacuation outlet 65 in correspondence with the centering ring 68, until the desired vacuum seal is obtained.

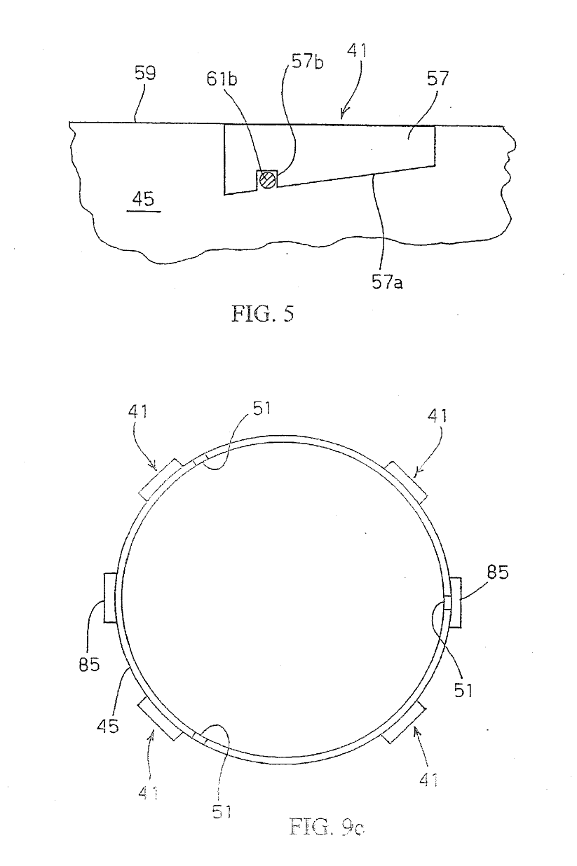

Referring now to FIG. 5, a variant of the first embodiment is shown in which at least one of the wedge-shaped prongs 57 comprises a notch or slot or indentation 57b made on the oblique surface 57a, to receive a wedge or prong or complementary pin 61b, positioned in correspondence with at least one bushing 61.

Preferably, the indentations 57b will be provided in correspondence with each of the wedge-shaped prongs 57, and there would be the same number of corresponding prongs or pins 61b. Additionally, said indentations 57b is positioned along the oblique surface 57a, preferably in proximity with the thicker side, to make an abutment surface so as to insure the correct securing of the joint and to avoid the accidental opening of the joint caused by the vibrations generated by the pump during its operation.

According to the invention, it will also be possible, obviously, to provide for either an inverted configuration with respect to the one described, wherein the indentations are provided on the bushings 61 and the on abutments over the wedge-shaped prongs 57, or a mixed configuration.

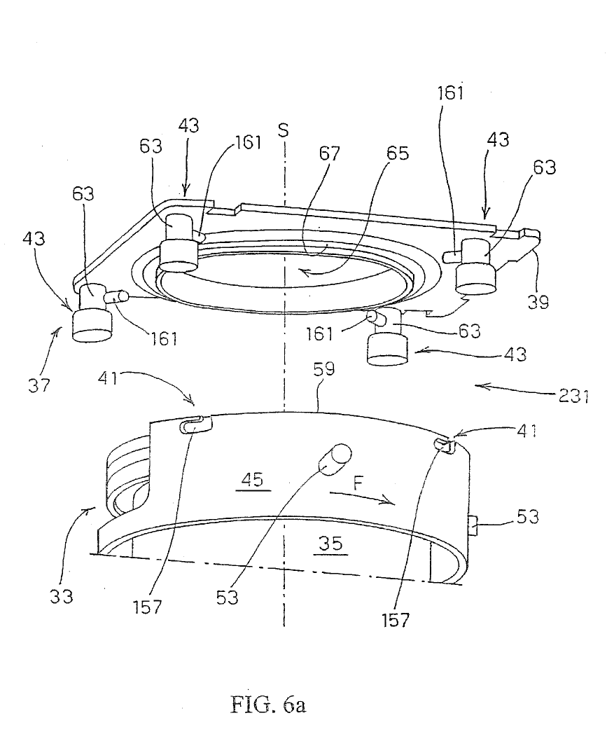

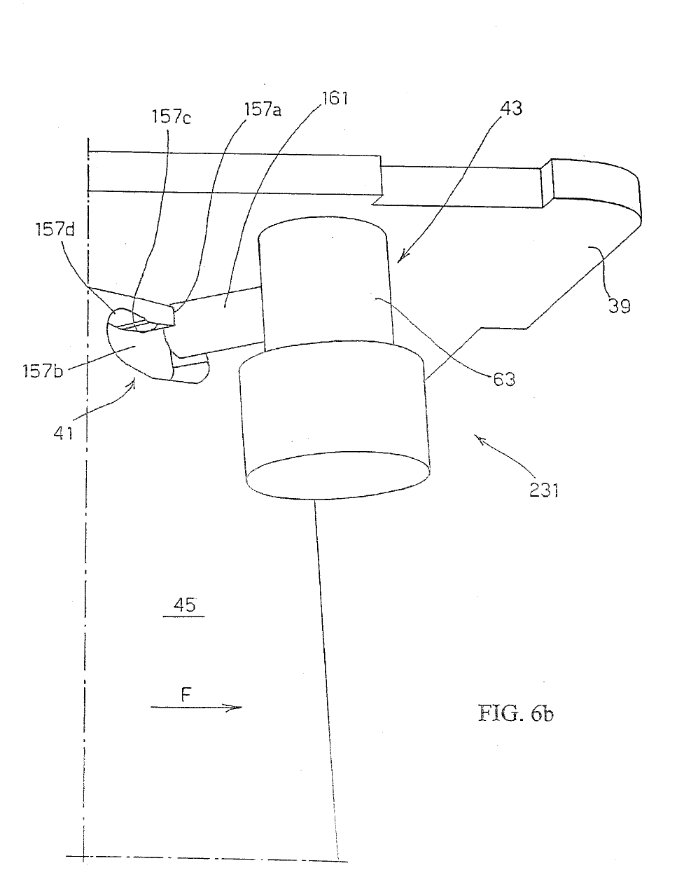

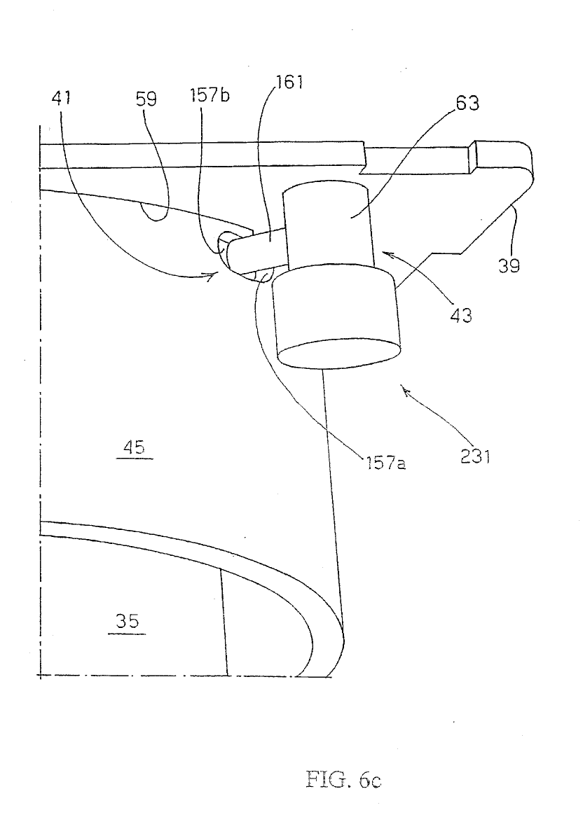

Referring now to FIG. 6a-6c, a second embodiment is shown, wherein the engagement elements 41 provided in correspondence with the flange 45 are defined as female engagement means and include four grooves or channels 157 positioned in a circumferential pattern along the front edge 59 of the flange 45, i.e. the edge toward the structure 39 and spaced 90° from one another.

According to this embodiment related to joint 231, the corresponding engagement elements 43, provided in correspondence with the opening 65, which is normally an evacuation outlet opening to which the pump is to be connected, are defined as male engagement elements, made with radial pins or plugs 161, connected to the respective supports or columns or studs 63, in turn connected, for example screwed, to the structure or frame 39 surrounding said opening 65, preferably positioned in correspondence with the vertices of a square centered on the opening 65, for a total of four engagement elements 43. Pins 161 would also be easily aligned along the square diagonals using a suitable template or special tool that will be described later in detail.

According to this embodiment, the grooves 157 are shaped so as to receive the pins 161 and to allow a stable, vacuum-tight connection of the pump inlet to the evacuation outlet. For this purpose, as better shown in FIGS. 6b and 6c, the grooves 157 comprise a first portion 157a, substantially axially oriented, open towards the edge 59, and a second round, wedge-shaped portion 157b, which is connected to the first portion 157a. The dimension of the groove 157 will also be designed to hold, substantially without clearance, the corresponding pin 161.

In this second embodiment, the securing of the joint 231 takes place as follows. The pump 35 is initially moved into contact with the evacuation outlet 65 using an approaching movement along the S axis of the pump, which is made to coincide substantially with the axis of the evacuation outlet 65, to which the pump is to be connected, until the radial pins 161 penetrate inside the first axial portion 157a of a corresponding groove 157 (FIG. 6b); subsequently, the flange 45 is rotated clockwise, right-handedly, in the direction of the arrow F, as illustrated in the example, to engage the radial pins 161 inside the grooves 157 by making them penetrate inside the second portion 157b of the grooves (FIG. 6c).

Advantageously, according to the invention, the second portion 157b will have a slanted abutment surface 157c, and will comprise a terminal portion 157d, which is also slanted but with opposite inclination, to receive the corresponding radial pins 161 and guarantee the complete securing of the joint 231, avoiding its accidental opening caused by vibrations during the operation of the pump.

Similarly to the discussion with reference to the first embodiment of the invention, the rotation of the flange 45 in the direction indicated by the arrow F, once the radial pins 161 are engaged inside the corresponding grooves 157, due to the slanted design of the abutment surface of the grooves, generates an axial reaction force that causes the suction inlet 25 of the pump 35 to move forward toward the evacuation outlet 65, while compressing the O-ring 67 positioned between them, until the required vacuum seal is obtained.

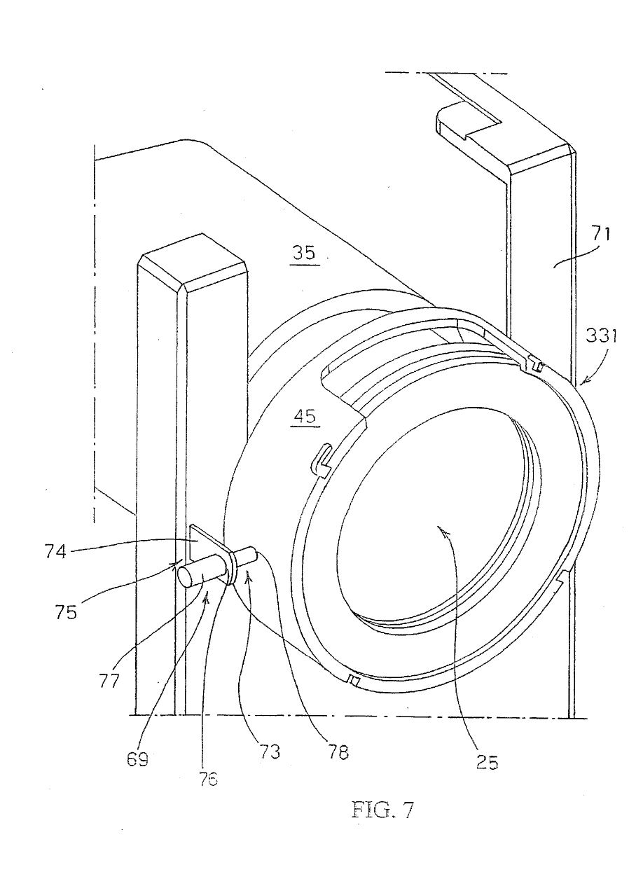

Referring to FIG. 7, a third embodiment of the invention is shown, in which the joint 331 defines a double connecting joint to connect the pump 35, not only to an evacuation outlet as previously described, but also to a supporting frame or case 71, inside which the pump 35 can be inserted during transportation and/or during the following operation.

In the embodiment illustrated in FIG. 7, the connecting joint 331 comprises a male/female joint 69 connected to the supporting frame or case 71, to which the pump can be connected using the joint 331. According to this embodiment of the invention, the flange 45 and the male/female joint 69 are equipped with respective engagement elements 73 and 75, which are complementary or connectable to each other using inter-connecting elements. In the illustrated example, the engagement elements 75 are obtained using the corresponding brackets 74 attached to the case 71 and provided with holes 76 for the passage of securing screws or pins 77. Similar the engagement elements 73, to be mounted on the flange 45, is define the respective slots or threaded holes 78 for the securing pins or screws 77. Furthermore, the pins or screws 77 will be engaged on said bracket 74 and on said flange 45, thus securing, though with possible clearance between the flange 45 and the pump 35, the flange 45, and, consequently, the pump 35 to the case 71.

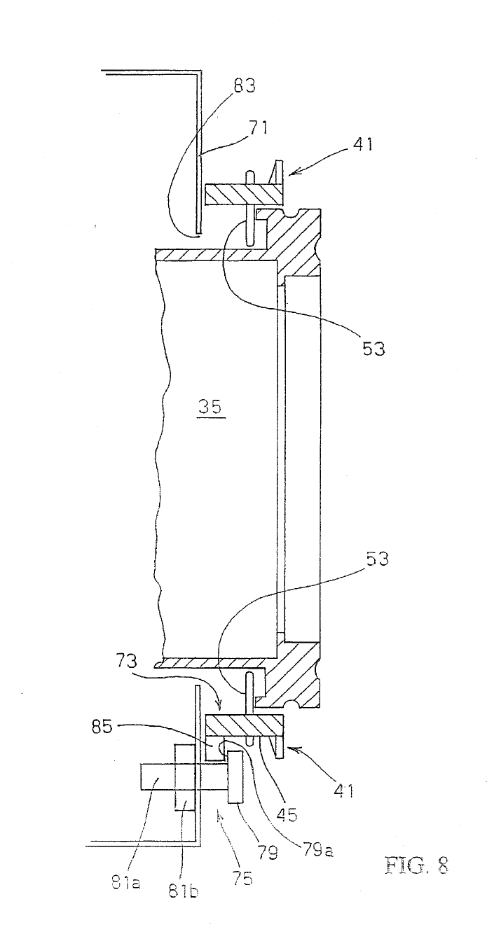

Referring now to FIG. 8, a first variant of the third embodiment of the invention is shown, wherein said engagement elements 75 are represented by corresponding bushings or washers or heads 79 connected to respective supports or columns or studs 81a, in turn associated with the case 71, by way of using the nut 81b, for example diametrically opposed to the sides of the aperture 83, from which the pump 35 protrudes, for a total of two engagement elements 75.

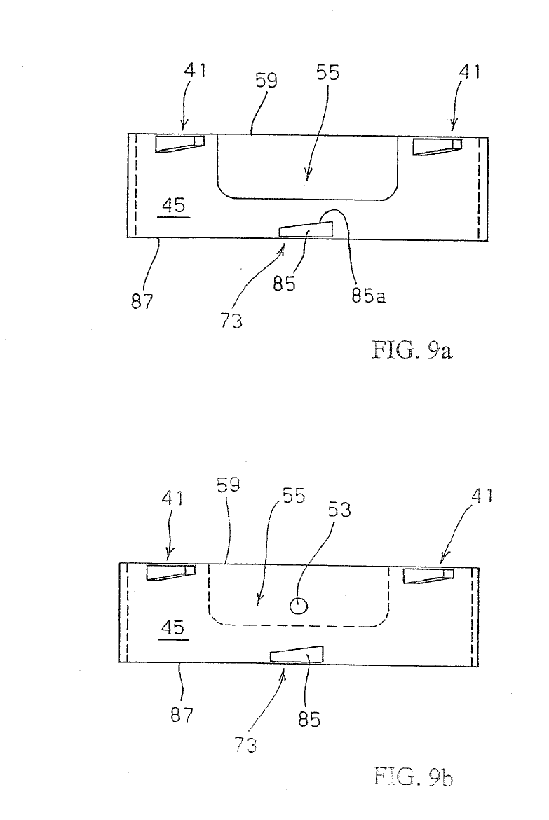

Correspondingly, as is more evident from FIG. 9a-9c, the flange 45 comprises respective wedge-shaped prongs 85 positioned in a circumferential pattern along or in proximity to the back edge 87 of the flange 45, which is the edge oriented toward the pump 35, and spaced out 180° from one another, for a total of two prongs 85.

The prongs 85 are advantageously used for the quick connection of the vacuum pump 35 to the case or frame 71. Prongs 85 are preferably very similar to the prongs 57, positioned in correspondence with, or in proximity to, the front edge 59 as described by the first embodiment of the invention. Similarly, the supports 81a and the bushings 79 to be mounted in correspondence with the aperture 83 on the case or frame 71 are preferably very similar to those to be mounted around the evacuation outlet 65 as described by the first embodiment of the invention.

Due to the joint here described, to connect the vacuum pump to the case or frame 71, it is sufficient to rotate the flange 45 with respect to the frame 71 in the same way as the connection of the flange 45 to the evacuation outlet 65 was previously described.

As better shown in FIG. 8, when the flange 45 is rotated, the oblique surfaces 85a of the wedge-shaped prongs 85 penetrate between the wall of the case 71 and the surface 79a of the bushing 79 until they interfere with said surfaces, securing the pump 35 to the case 71. According to the invention, it is possible also to configure engagement elements 75 and the corresponding engagement elements 73 according to the described configuration of the second embodiment of the invention.

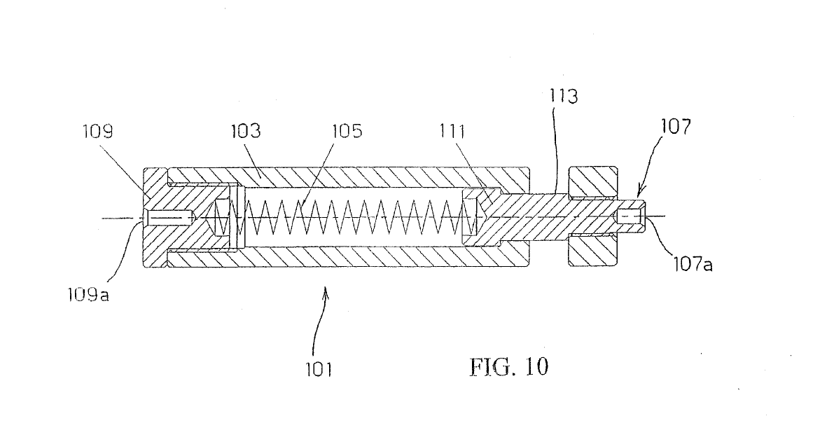

Referring now to FIG. 10, the following is the description of an embodiment of an extensible tool 101 for centering the engagement elements 43 or 75. The tool 101 comprises an elongated tubular body 103 to which a mobile head 107 is connected, preferably using the interposition of an elastic element 105, said mobile head axially sliding with respect to the body 103.

In the illustrated example, the body 103 is of a hollow, cylindrical shape, and receives the elastic element 105, consisting of a spiral spring. Inside the cavity of the body 103, there is a cursor 111 that can slide inside the hollow body 103, against the resistance of the spring 105. The cursor 111 is connected to the mobile head 107 by way of the stem 113 that protrudes from one end of the hollow body 103; a fixed head 109 closes the opposite end of the body 103 and defines a corresponding abutment surface for the spring 105. Advantageously, the fixed head 109 and the mobile head 107 have corresponding axial slots 107a and 109a, designed to receiving the anchoring pins 161 or similar elements that make up the engagement elements 43 or 75.

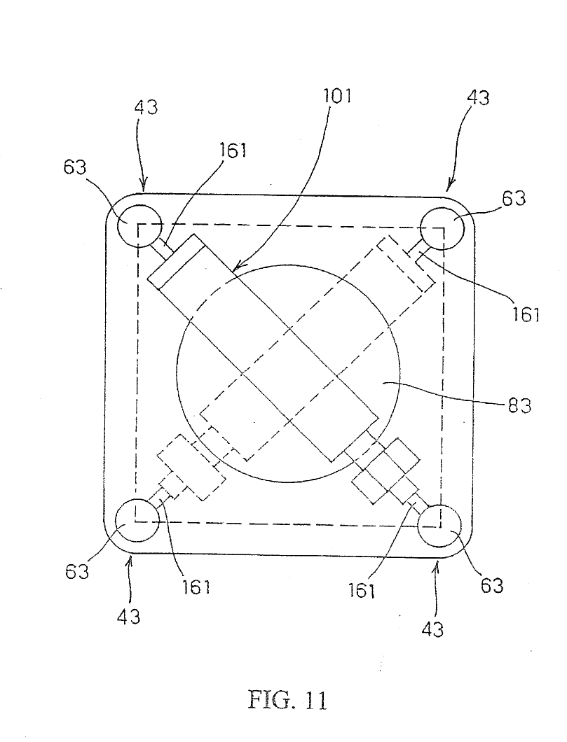

As schematically illustrated in FIG. 11, the described tool can be used, advantageously, to align the pins 161 along the diagonals of a hypothetical square centered on the corresponding outlet 65 or aperture 83 to which the pump is connected, before the securing of the columns 63 and 81a.

It is evident from the above that the connecting device according to the invention achieves the pre-established objects of the invention because it provides a quick and reliable vacuum-tight connection between a vacuum pump and the corresponding chamber to be evacuated and/or the case or supporting frame of the pump.

It is also evident that the above detailed description cannot be intended as a limitation, and numerous variants and modifications are possible without deviating from the scope of the invention.

What is claimed is:

1. A male joint (33; 37) for vacuum pumps suitable for providing the mechanical connection with a compatible female joint (37; 33), so as to establish a vacuum seal between a suction inlet (25) of a vacuum pump (35) and an evacuation outlet (65) of a structure (39) to which the pump is to be connected; said male joint (33; 37) comprising:
a plurality of male engagement elements (41; 43) and being connectable to the vacuum pump outer case or to the structure to which the pump is to be connected;
said male engagement elements providing a mechanical connection with respect to the corresponding female engagement elements (41; 43) of said female joint;
wherein the mechanical connection is obtained by the relative rotating movement between the said male joint (33; 37) and said female joint (37; 33).

2. A female joint (37; 33) for vacuum pumps suitable for providing the mechanical connection with a compatible male joint (33; 37) so as to establish a vacuum seal between the suction inlet (25) of a vacuum pump (35) and the evacuation outlet (65) of a structure (39) to which the pump is to be connected; said female joint (37; 33) comprising:
a plurality of female engagement elements (41; 43) and being connectable to the vacuum pump outer case or to the structure to which the pump is to be connected;
said female engagement elements providing a mechanical connection with respect to the corresponding male engagement elements (41; 43) of said male joint;
wherein the mechanical connection is obtained by the relative rotating movement between said male joint (33; 37) and said female joint (37; 33).

3. The male joint according to claim 1, wherein said male joint is made a single body with said pump (35) or with said structure (39).

4. The male joint according to claim 1, further comprises a flange (45), which is connectable to the vacuum pump in correspondence with the gas suction inlet (25) and is provided with securing elements (53) preventing its separation from said pump (35) when said flange (45) and said pump are interconnected, wherein said flange receives at least a portion of the outer case (11) of said vacuum pump (35).

5. The male joint according to claim 4, wherein said securing elements (53) comprise at least one pin or one screw (53) having such a length and being mounted on the flange (45) in such a way as to allow the, at least partial, relative rotation of the flange (45) with respect to the pump (35).

6. The male joint according to claim 4, wherein said male engagement elements (41; 43) comprise corresponding wedge-shaped prongs (57) distributed in a circumferential pattern on a lateral surface of the flange (45) in correspondence with, or in proximity to, a front edge of the flange (45), wherein the edge is oriented toward the structure (39) to which the pump is to be connected.

7. The male joint according to claim 6, wherein at least one of the wedge-shaped prongs (57) comprises an oblique surface (57a) with a notch or a slot or an indentation (57b) thereon for receiving a complementary abutment or prong or pin (61b), which is provided in correspondence with at least one of the female engagement elements (41; 43).

8. The male joint according to claim 4, wherein said flange (45) further comprises a second plurality of male/female engagement elements (73) for connecting the vacuum pump (35) to a compatible female/male joint (69) connectable to a case or frame (71) supporting said pump, said second male/female engagement elements providing the mechanical connection with respect to corresponding female/male engagement elements (75) provided in said compatible female/male joint

9. The male joint according to claim 1, wherein the male engagement elements (41; 43) comprise radial pins or plugs (161), which are associated to corresponding supports or columns or studs (63) connectable to the structure (39) to which the pump is to be connected, said supports or columns or studs (63) being provided in correspondence with the vertices of a square, for a total of four male engagement elements (41; 43).

10. The female joint according to claim 2, wherein said female joint is made as a single body with said pump (35) or with said structure (39).

11. The female joint according to claim 2, wherein said female joint is connectable to the structure (39) to which the pump is to be connected, in correspondence with the gas evacuation outlet (25).

12. The female joint according to claim 11, wherein said female engagement elements are made with corresponding bushings or washers or heads (61) defining corresponding female slots (62) associated with corresponding supports or columns or studs (63), connectable to the structure (39) to which the pump is to be connected, and wherein the supports or columns or studs (63) are in a number of four and are positioned in correspondence with the vertices of a square.

13. The female joint according to claim 2, wherein said female joint comprises:
a flange (45) connectable to the vacuum pump in correspondence with the suction inlet (25), said flange is dimensioned in such a way as to receive at least a portion of the outer case (11) of said vacuum pump (35) and is provided with securing elements (53) preventing its separation from said pump when said flange and said pump are connected to one another; and said securing elements (53) comprise at least one pin or screw (53) having such a length and being mounted on the flange (45) in such a way as to allow the relative, at least partial, rotation of the flange with respect to the pump (35).

14. The female joint according to claim 13, wherein said female engagement elements (41;43) comprise corresponding grooves or channels (157) distributed in a circumferential pattern on the lateral surface of the flange (45),
wherein said grooves or channels (157) are distributed in correspondence with, or in proximity to, the front edge of the flange (45), which is the edge to be mounted facing the structure to which the pump is to be connected, and
wherein said grooves or channels comprise a first portion (157a), which is substantially axial, open towards the edge (59), and a second wedge-shaped circumferential portion (157b) connected to the first portion (157a), the dimension of the groove (157) is chosen to receive, substantially without clearance, the corresponding male connecting element.

15. The female joint according to claim 14, wherein said flange (45) further comprises a second plurality of male/female engagement elements (73) for connecting the vacuum pump (35) to a compatible female/male joint (69) connectable to a case or frame (71) supporting said pump, said second male/female connecting elements providing the mechanical connection to corresponding female/male engagement elements (75) provided in said compatible female/male joint.

16. A split joint comprising a male joint according to claims 1, 4-8 or 1, 9 and a female joint according to claims 2 and 10-12, or a male joint according to claims 1, 3, 9, and a female joint according to claims 2, 11-12 or 2,13-15.

17. A vacuum pump comprising an outer case (11) housing gas pumping stages (13), obtained by the cooperation between stator rings (15), integral with an outer case (11) of the pump, and rotor discs (17), integral with a rotating shaft (19) which is driven by an electric motor (23), said outer case defining an axial inlet port (25) for the intake of pumped gases, characterized in that said outer case comprises a male joint according to any of the claims 1 and 4-9 or a female joint according to any of the claims 2 and 10-15.

18. A method for obtaining a split joint for vacuum pumps for establishing a vacuum seal between the suction inlet (25) of a vacuum pump (35) and an evacuation outlet (65) in a structure (39) to which the pump is to be connected; said method comprising the steps of:
providing a male joint provided with a plurality of male engagement elements (41; 43), said male joint being connectable to the outer case of a vacuum pump/to the structure to which the pump is to be connected;
providing a female joint provided with a plurality of female engagement elements (41; 43), said female engagement elements providing the mechanical connection to said corresponding male engagement elements (41; 43) of said male joint, said mechanical connection being achievable by a relative rotating movement between said male joint (33; 37) and said female joint (37; 33), said female joint being connectable to the structure to which the pump is to be connected/to the outer case of the vacuum pump;
connecting said male/female joint to said vacuum pump; and
connecting said female/male joint to said structure.

19. The method according to claim 18, wherein said step of connecting said male/female joint to said structure, comprising the step of aligning said engagement elements along square diagonals.

20. The method according to claim 19, wherein said aligning step is carried out by using an extensible tool (101) comprising a tubular straight body (103); a head (107) axially movable with respect to the tubular body (103) against the resistance of an elastic element (105) mounted inside said body; a fixed head (109); wherein said heads (107, 109) are provided with corresponding axial slots (107a, 109a), suitable for cooperating with said engagement elements.
